(19) United States
(12) Patent Application Publication
(10) Pub. No.: US 2026/0328398 A1
(43) Pub. Date: Oct. 22, 2026

(54) FOOD PROCESSING SYSTEM

(71) Applicant: PRECITASTE INC., New York, NY (US)

(72) Inventor: Al INDIG, New York, NY (US)

(73) Assignee: PRECITASTE INC., New York, NY (US)

(21) Appl. No.: 19/114,722

(22) PCT Filed: Sep. 22, 2023
(86) PCT No.: PCT/IB2023/059399

§ 371 Date: Mar. 24, 2025

(30) Foreign Application Priority Data
Sep. 23, 2022 (EP) 22197589.9
Dec. 9, 2022 (EP) 22212667.4

(51) Int. Cl. F24C 7/08; A47J 36/32

(52) U.S. Cl. CPC F24C 7/085; A47J 36/321

(57) ABSTRACT

The disclosure is related to a food processing system, which comprises a sensor unit for determining holding data of at least one pan or holding container placed in a food holding area. The system further comprises a processing unit for determining a scheduling state based on current holding data and/or a holding data history; and a control unit to control an actuator based on the determined scheduling state.

### CROSS-REFERENCE TO RELATED APPLICATION

This application is the U.S. national phase of PCT Application No. PCT/IB2023/059399 filed on Sep. 22, 2023, which claims priority to European Patent Application No. EP 22197589.9 filed on Sep. 23, 2022, and European Patent Application No. EP 22212667.4 filed on Dec. 9, 2022, the disclosures of which are incorporated herein in their entireties by reference.

### BACKGROUND

Restaurants and other retailers that sell fresh food have to manage their inventory levels to match the sales demand throughout the day. At present, solutions are lacking to manage the inventory level autonomously. Technologies are lacking that do not need to be managed by employees, which makes them imprecise and costly to maintain and run.

Depth sensors exist to measure the amount of inventory that's available to serve, but these are typically complex, requiring a computer scientist or engineer to determine which sections of the pixel data to measure. Further, these sensors need to be calibrated in order to provide useful information.

When these sensor systems are installed and functioning, sensing the available fresh inventory is only one of the inputs to the management of production scheduling. Additionally, the system must forecast demand, determine how long the existing inventory will last, and order the production of more food when the available inventory will not last longer than the production time. Furthermore, there are constraints related to the equipment used for cooking and to the available labor in the kitchen. The system must order the production of more food earlier than it otherwise would if there are constraints on the available labor or equipment.

In addition, restaurants have always aimed to provide fresh food quickly and accurately to their customers. Since the proliferation of digital Point of Sale (POS) and other simple data-based systems, restaurants have had basic data about specific moments such as the moment an order is entered into the POS system or bumped off of the production queue by a user. However, systems for tracking and interpreting actual live events in restaurants' back-of-house have been lacking for decades.

In this context, also properly managing the equipment used for cooking to minimize human error in using preheating devices and appliances such as ovens, is another important aspect.

For example, there is a lot of potential in effectively managing the preheating temperatures of ovens in view of energy saving, quality and efficient use of labor.

In greater detail, keeping ovens preheated without using them is a waste of energy.

Moreover, powering ovens down and starting to use them without proper preheating phases diminishes the quality of food products of food items. The same holds for cooking food products with an incompatible preheating temperature or using cooking profiles not suited for the food items to be baked.

Conventional management systems may offer a device interface but are static otherwise, which causes energy waste if employees don't use the device immediately after completing the preheating, or if the used food product differs from those planned.

Moreover, other related management systems may aim at preventing usage mistakes on a device level, but may lack integration of preheating workflows. They may further aim at solving all issues in one self-contained, closed system, which fails in practice as the location where food products or items are prepared and where they are cooked may be physically distant and thus not allow for monitoring with one system. Or they may fail to capture the complexity of all involved steps and are thus are not flexible enough for successful deployment in real-life environments.

### SUMMARY

The present disclosure provides two separate, loosely connected workflows for preheating management and quality control that either interfaces with a device or appliance directly, or with the human operator using a user interface (UI), or with a combination of both. Separating the workflows removes the need for interruption-free end-to-end tracking of products from their preparation until they are cooked and thus enables to deliver a working system quickly in complex environments.

The present disclosure provides a system or food production system and/or food processing system and/or scheduling system and/or tracking system and/or tracking and scheduling system that enables efficient planning and control of food preparation and/or food supply.

In greater detail, the system uses modern computer vision and AI technology to sense and digitize real events as they happen, which may include: the usage of ingredients; the construction of a sandwich, burrito, salad, or bowl of food; the serving of an ingredient that carries an upcharge; the replenishment of a food item; the presence or lack of ingredients on assembly lines throughout the day; or tracking the actual freshness of an ingredient on a buffet or assembly line. The system uses this new real-time data to streamline operations and guide human operators to make excellent decisions and effectively do their tasks in view of all of the information available in the restaurant.

Specifically, the system addresses the needs arising in the cases regarding Production Planning such as Cook to Needs, or “What to Cook When”, and/or Order Accuracy, and/or Upcharge Management, and/or Cashierless Checkout.

For example, in a busy restaurant, crew members don't always know when is the right time to cook food. Furthermore, they can easily be distracted by the many tasks that need to be done during their shifts. The system including Production Planning as described therein has the goal of guiding crew to produce the ideal amount of several food ingredients at each moment throughout the day. The system accomplishes this by sensing available supply of each food, predicting the upcoming demand for each food, and triggering a cook process or actuator when the supply and demand are projected to be unbalanced. Further functions of this system may include timing foods' freshness and triggering a cook process when the existing food is unacceptably unfresh. Furthermore, these systems can prioritize among the backlog of tasks that restaurant workers often have to do at busy times.

Furthermore, Order Accuracy modules monitor the production of food items and/or the assembly process for orders. By tracking scooping or service events with advanced sensing, the system determines for instance which ingredients have and have not been added to a sandwich, bowl, salad, or other food item. The systems compare the list of added ingredients against the list of ingredients that should have been added according to the order.

Two similar use cases result when detailed POS data is not available, such as at buffets or customer-facing make lines: Upcharge Management and Cashierless Checkout. These use cases use scooping or service events to compile a list of ingredients that were actually added to each item. For Upcharge Management, the system triggers an actuator when items are added that should carry an upcharge. This ensures that all items that are meant to be charged to customers are actually charged. Cashierless Checkout gathers the full list of ingredients that have been added to the order, then sends this information to a POS screen that compiles the list. This list may be confirmed by a worker or customer in the restaurant.

In particular, this object is solved by a food processing system comprising: a sensor unit for determining holding data or food holding data of at least one pan, container, or food holding container placed in a holding area or food holding area; a processing unit for determining a scheduling state or food scheduling state based on current holding data or food holding data and/or a holding data history or food holding data history; and a control unit to control an actuator based on the determined scheduling state or food scheduling state.

The system is able to control an actuator, such as a robotic process, or to inform personnel to prepare food in good time on the basis of data indicating current or previous consumption of food. This makes it possible to keep cooked food available without delay times.

The sensor unit can comprise at least one of an RGB sensor, or other optical sensor, and at least one of a depth sensor, a thermal sensor, a 3D camera, a time of flight sensor, or a stereo camera. Said sensors are physically installed in a fixed position and orientation relative to each other. The combination of optical data and depth data allows tracking the depletion rate of food within the pan, container, or food holding container in detail.

In this context, the holding data or food holding data can comprise information about at least one of a fill level of the at least one pan, container, or food holding container, a holding time or food holding time of the at least one pan, container, or food holding container, a food ingredient associated with the food in the pan, container, or food holding container, information about the availability of the food ingredient, and a food ingredient preparation time. The scheduling state or food scheduling state can comprise information about the types of food that should be cooked or prepared, the quantity of food that should be cooked or prepared, the destination where the food should be brought, the priority level relative to other scheduled foods, and/or the timing of when the food should be finished cooking or preparing. A cook command is a message communicating information comprised in the scheduling state or food scheduling state, either to initiate a robotic automation process or to instruct a human operator to begin a cook or preparation process.

The system can determine the fill level based on 3D pixel data of the holding area or food holding area.

Said 3D pixel data can be calculated by the system based on correlating 2D pixel sensor data and depth sensor data, which are determined by the sensor unit.

The system can then determine regions of interest within the sensor unit's field of view based on the 3D pixel data. It is advantageous to associate measured distances or depths with fill levels of at least two regions of interest different from one another,

In addition, the system can determine a heat state fill level based on enhanced 3D pixel data of the holding area or food holding area by correlating 2D temperature sensor data with 2D pixel sensor data and depth sensor data, which are determined by the sensor unit. With said advanced information also the heat state of the food in the pan, container, or food holding container is taken into consideration.

The scheduling state or food scheduling state can be based on the current fill level and/or current heat state fill level.

Based on the scheduling state or food scheduling state, the control unit can identify a replenish event when a specific fill level of the pan, container, or food holding container is reached. It can start a timer by the replenish event for a predefined ingredient specific holding time. It can initiate cook commands to a grill, stove, fryer, toaster, ice machine, oven, coffee maker or beverage dispenser crew person or initiate an automated robotic process once a predefined time is reached. Moreover, the control unit can initiate replenish commands to exchange the pan, container, or food holding container once a predefined time is reached.

The scheduling state or food scheduling state can be based on a holding data history or food holding data history, wherein, based on the scheduling state or food scheduling state, the control unit can further forecast from previous sales volume or current customer traffic the necessary food item quantity or weight to be cooked in a certain time frame. It can augment the forecasting by adding local events, weather, calendar holidays, or other modifications into the calculation of current and future demand. It is able to identify reorder points using the information of anticipated consumption, to initiate cook commands once fill levels drop below a calculated threshold. Furthermore, the control unit can calculate different reorder points for each time of day and for each ingredient individually.

Thus, the whole food preparation and planning process can be automated saving time and costs.

The system further comprises a display unit that is adapted to display the fill levels of the pan, container, or food holding container, available inventory, specific cook commands, action items or requests of a crew person, and/or a destination area for the pan, container, or food holding container. Furthermore, the system is adapted to prioritize cook commands based on demand and available inventory.

The system can apply vision AI to monitor a grill surface or other cooking device, and identifies what food ingredients are in the process of cooking.

The above object is also solved by a computer implemented method for processing food, the method comprising the following steps:
determining holding data or food holding data of at least one pan, container, or food holding container placed in a holding area or food holding area;
determining a scheduling state or food scheduling state based on current holding data or food holding data and/or a holding data history or food holding data history; and
controlling an actuator based on the determined scheduling state or food scheduling state.

Furthermore, additional steps can be performed, comprising:
identifying a replenish event when a specific fill level for the pan, container, or food holding container is reached;
starting a timer by the replenish event for a predefined ingredient specific holding time;
initiating cook commands to a grill, stove, fryer, toaster, ice machine, oven, coffee maker or beverage dispenser crew person or initiate an automated robotic process once a predefined time is reached; and
initiating replenish commands to exchange the pan, container, or food holding container once a predefined time is reached.

The above object is also solved by a computer program comprising instructions that, when executed by a system, cause the system to execute the above described method.

The above object is also solved by a food tracking and scheduling system, comprising:
a sensor unit for detecting at least one tray or loading system placed in a food holding area and determining holding data of the at least one tray or loading system;
a processing unit for determining a cooking schedule based on the holding data and/or a holding data history and selecting a cooking device based on the determined cooking schedule; and
a control unit to control an actuator based on the determined cooking schedule.

The sensor unit may comprise at least one of an RGB sensor, or other optical sensor, and at least one of a depth sensor, a thermal sensor, a 3D camera, a time of flight sensor, or a stereo camera.

The holding data may comprise information about the kind and number of food items in the tray or loading system.

The cooking schedule may comprise information about the availability of the cooking devices, a current state of the available cooking devices, and a usage pattern of the available cooking devices.

The cooking schedule may also comprise a digital baking schedule configured to substitute or add information to the holding data.

Based on the holding data and the cooking schedule, the control unit may be further adapted to:
recognize the tray and/or additional trays within the food holding area;
identify and classify the food items in the tray and/or the additional trays within the food holding area,
in case that the food items are not compatible to be cooked in combination with each other, generate a warning to be displayed on a user interface;
in case that a loading system is detected, determine the loading systems height and track the loading system;
select a cooking program;
select a cooking device;
provide information regarding the loading system, the trays, the cooking program and the cooking device to a quality control system;
start preheating the cooking device; and
start preheating the cooking device.

The cooking schedule may be further based on a holding data history, wherein, based on the cooking schedule, the control unit is further adapted to:
forecast from previous demands the food item quantity to be cooked in a certain time frame.

The system may further comprise a display unit that is adapted to display a warning that the tray comprises mixed food items and an interface for controlling cooking devices.

The above object may also be solved by a quality control system comprising a sensor unit, wherein the quality control system is configured to:
in case that a cooking device is opened and receives food items:
determine if a loading system is present in a food holding area;
if a loading system is present, recall the loading system and loaded food items based on information provided by a food tracking and scheduling system;
compare a selected cooking program based on the information provided by the food tracking system with a program to be executed on the cooking device;
in case that the selected cooking program is not compatible with the cooking program to be executed, generate a warning to be displayed on a user interface;
in case that the selected program is compatible with the cooking program, start the cooking program when the cooking device is closed.

The quality control system may be further configured to:
if a loading system is not present, recognize a tray and/or additional trays within the food holding area;
identify and classify the food items in the tray and/or the additional trays within the food holding area;
compare a selected cooking program based on the information provided by the food tracking system with a program to be executed on the cooking device;
in case that the selected cooking program is not compatible with the cooking program to be executed, generate a warning to be displayed on the user interface;
in case that the selected program is compatible with the cooking program, start the cooking program when the cooking device is closed.

The quality control system may be comprised in a food tracking and scheduling system described above.

The above object may also be solved by a computer implemented method for tracking, scheduling and controlling the quality of food, the method comprising:
recognizing a tray and/or additional trays within a food holding arca;
identifying and classifying food items in the tray and/or the additional trays within the food holding area;
in case that the food items are not compatible to be cooked in combination with each other, generating a warning and to be displayed on a user interface;
in case that a loading system is detected, determining the loading systems height and tracking the loading system;
selecting a cooking program;
selecting a cooking device;
providing information regarding the loading system, the trays, the cooking program and the cooking device to a quality control system; and
starting preheating the cooking device.

The method may further comprise:
in case that a cooking device is opened and receives food items:
determine if a loading system is present in a food holding area;
if a loading system is present, recall the loading system and loaded food items based on information provided by a food tracking and scheduling system;
compare a selected cooking program based on the information provided by the food tracking system with a program to be executed on the cooking device;
in case that the selected cooking program is not compatible with the cooking program to be executed, generate a warning to be displayed on the user interface;
in case that the selected program is compatible with the cooking program, starting the cooking program when the cooking device is closed.

The method may further comprise:
if a loading system is not present, recognize the tray and/or additional trays within the food holding area;
identify and classify the food items in the tray and/or the additional trays within the food holding area;
compare a selected cooking program based on the information provided by a food tracking system with a program to be executed on the cooking device;
in case that the selected cooking program is not compatible with the cooking program to be executed, generate a warning to be displayed on the user interface;
in case that the selected program is compatible with the cooking program, starting the cooking program when the cooking device is closed.

The above object may also be solved by a computer program comprising instructions that, when executed by a system, cause the system to execute the method described with regard to food tracking, scheduling and quality control.

### BRIEF DESCRIPTION OF DRAWINGS

FIG. 1 shows a simplified schematic view of an example food processing system.

FIG. 2 shows a simplified schematic view of an example holding area or food holding area comprising pans or food holding containers.

FIG. 3 shows an example for adjusting depth readings.

FIG. 4 shows examples of RGB and stereo sensor placements for a pixel coordinate correlation between a depth and an RGB image.

FIG. 5A shows an example of a food tracking and scheduling system.

FIG. 5B shows an example of the food tracking and scheduling system.

FIG. 6 shows an example of the food tracking and scheduling system.

### DETAILED DESCRIPTION

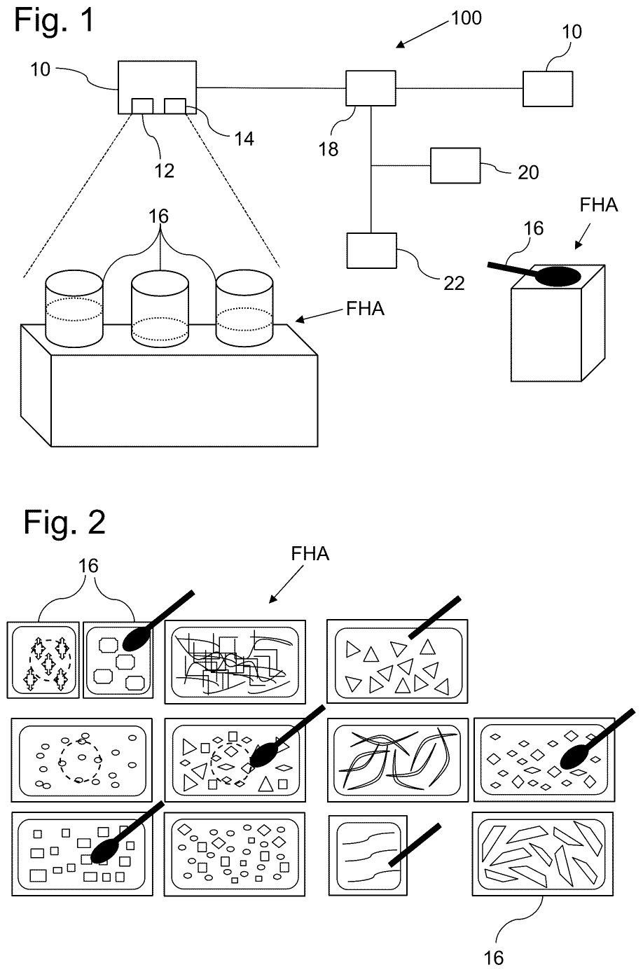

FIG. 1 shows a simplified schematic view of a food processing system 100 according to an embodiment of the present disclosure. In particular, the present disclosure is related to a system 100 and method for aligning sensors for food production scheduling. The system 100 comprises a sensor unit 10, a processing unit 18, and a control unit 20.

The sensor unit 10 determines holding data or food holding data of at least one pan 16 or food holding container 16 placed in a holding area or food holding area FHA. The at least one pan 16 or container 16 is representative for all possible food containers, receptacles, pan mounts and/or food storage or preparation utensils.

The processing unit 18 determines a scheduling state or food scheduling state based on current holding data or food holding data and/or a holding data history or a food holding data history.

Based on the determined scheduling state or food scheduling state, the control unit 20 controls an actuator 22. The actuator 22 can be a crew personal such as a cook that receives cook commands from the control unit 20 to prepare and cook a specific food ingredient. In addition, the control unit 20 can also initiate an automated robotic process to prepare and cook food.

The processing unit 18 and the control unit 20 each may comprise a computer, a virtual machine or container running on a computer, or a software suite running on a computer. The processing unit 18 and the control unit 20 each may contain memory for holding data to process, processing power to make computations and execute program instructions stored in the memory.

The sensor unit 10, the processing unit 18, the control unit 20, and the user interface or display unit may be connected via a network for moving data between them. This network may include connections such as physical ethernet, Wi-Fi® or other LAN connections, WAN, VPN, cellular, Bluetooth®, or other connections for transferring data between system components and to users both onsite and remote to the system.

In the following the sensor unit 10 and the processing unit 18 are described in detail.

### Sensor Unit 10 and Processing Unit 18

Identifying different pans 16 or pan mounts and dimensions in an image and using image coordinates to identify a normalized image or depth map that corrects different observation points in at least two different measurement setups.

Correlating an RGB sensor's 12 pixel coordinates with a depth sensor's 14 pixel coordinates to determine the pixel coordinates of an item in the depth sensor's field of view. Using computer vision or other types of processing to locate items on the RGB stream's pixel coordinates in real time, and to draw depth measurements from a pixel area defined by the processing of the RGB stream.

In general, the sensor unit 10 comprises an RGB sensor 12 or other optical sensor 12 and an additional sensor 14, which may be any one or a combination of digital sensors including depth sensors, thermal sensors, 3D cameras, time of flight sensors, or stereo cameras, which may depend on the desired sensing result or results. The RGB sensor 12 or other optical sensor 12 may provide a stream of data or images in the form of pixel data, which can be used to find objects or target regions of interest in the sensor's field of view or pixel coordinates. The RGB 12 or other optical sensor 12 may be physically installed in a fixed position and orientation relative to the additional sensor 14. Thus, the present solution can set the regions of interest and calibrate the sensors to provide information to the user that is relevant to the operations of a restaurant.

In general, the processing unit 18 may receive as an input the stream of data or images from the RGB 12 or other optical sensor 12, and may perform processing by method of computer vision, algorithmic image processing, corner detection, blob detection, or edge detection or other pixel data processing method, and may send as an output a stream of images annotated with the pixel coordinates and/or pixel size of various objects or regions of interest in the sensor's field of view.

The additional sensor 14 may receive as an input the annotated stream of images from the processing unit 18, to determine where in its field of view lie certain specified objects or regions of interest. The additional sensor 14 may use the annotations to determine a direction, a pixel, or a group of pixels for measurement. The additional sensor 14 may measure the depth, temperature, or other parameters of the direction, pixel, or group of pixels specified by the processing unit.

The preferred additional sensor 14 is a sensor 14 that can measure a distance for at least one point, including TOF (time-of-flight), LIDAR, 3D or stereo camera setup, including illumination unit including visible light wavelength as well as infrared wavelength, including advantageously a 3D camera setup that also includes a RGB image of the same arca it monitors with depth sensing.

### Sensing Hardware

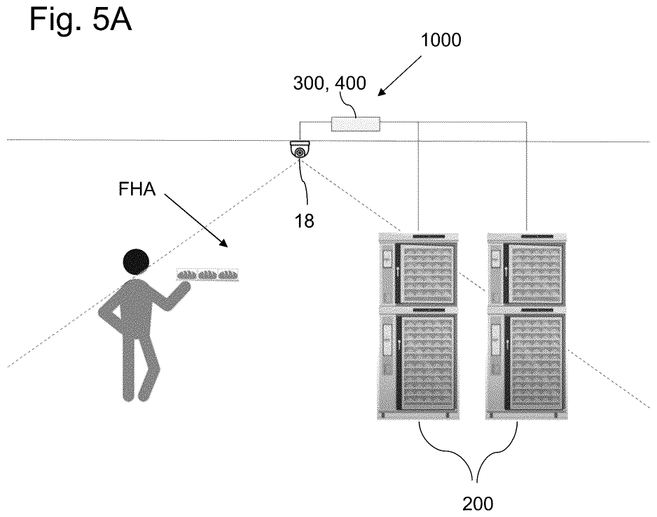

In order to combine data from the RGB sensor 12 and the depth sensors 14, it is advantageous to align the sensors close to one another, at a predefined distance that enables the correlation of pixel coordinates between the two sensors, see for example FIG. 4 illustrating several arrangements For example, it can be beneficial to place two stereo sensors 4.8-9.7 cm (2.1-3.8 inches) apart, with the RGB sensor 12 either in between the two stereo sensors or 1.27-2.03 cm (0.5-0.8 inches) away from the closer depth sensor. Especially when longpass filters are being used to eliminate reflections from LED lighting, it is advantageous to add Infrared projectors to add patterns and texture to the images, in order to add greater resolution and accuracy to the measurements. The infrared projector may be positioned halfway between the two stereo sensors, or within the center third of the distance between the two stereo sensors. It may also be possible to combine multiple IR projectors to reduce noise and improve sensing accuracy. Depending on the requirements of the environment, different stereo or other depth sensing configurations may be advantageous.

For instance, stereo sensors that are farther apart from one another have a greater accuracy at long distances, whereas stereo sensors that are closer together have better accuracy at short range. Depending on the mounting location, one sensor solution or another may have an advantage for reasons of depth sensing accuracy, field of view, or other technical considerations of the sensor suites.

For AI and other processing that uses RGB sensing, it is advantageous to set up the hardware to remove problems that are specific to the kitchen or restaurant environment. For instance, foods that are on display for customers are often subject to harsh irritating light. This light can often generate reflections that cause problems both for vision AI and for stereo depth sensing. Thus it is advantageous to use optical filters to remove irritating light for the sensors. The type of filter may depend on the source of the interfering light. A longpass filter may be used for blocking bright LEDs. An IR blocking filter may be used if the source of the interference is mostly IR. A wide-band interference, like bright sunlight, may be counteracted with either filter. That is, examples include using longpass filters for the depth sensing units to remove reflections from LED lights, particularly with cutoff wavelengths between 725-850 nm; using shortpass filters on windows or glass to remove reflected sunlight; using shortpass filters to remove infrared from a heat source such as a heat lamp; using linear or radial polarizers to remove reflections that occur at specific parts of the image; or using linear or radial polarizers both on the sensors and on windows, clear shields, sneeze guards, or light sources, but rotated 90 degrees from the polarizers on the sensor, or otherwise aligned to filter out all light from a specific light source.

The meaningful information in a make line or buffet table is drawn from inside of the pans. Therefore, it is advantageous to select a top-down viewpoint, enabling the sensors to view and measure the space inside each pan. Generally, this top-down viewpoint is selected with the ingredients of interest positioned as close as possible to the center of the image. It is also advantageous to position the sensor in such a way as to avoid occlusions to the areas of interest. For example, many food assembly lines have over the food a sneeze guard or food guard, or other shield that is generally made from a clear material such as glass or acrylic. Stereo sensors can see through such shields, but not through the materials that hold the guards, nor through the reflections that are often cast onto the shields. For effective vision classification and depth readings, it is advantageous to position the sensor in such a way that such occlusions and reflections are positioned in between areas of interest, rather than directly above them. It is advantageous to position the sensor square with the make line, so that as often as possible, areas of interest can be square with the pixel coordinates of the sensor.

The top-down viewpoints can be achieved in different ways depending on the requirements of the surrounding areas. For instance, customer-facing service areas are generally very open and allow for the best viewing angle when mounted on the ceiling. Other make lines may have shelves, hoods, or other equipment above them that would occlude the areas of interest if sensors were mounted to the ceiling. In these cases, equipment integrations are often advantageous. One example is a retrofittable shelf piece, with sensors mounted inside of the shelf piece such that the glass surface of the sensors is flush with the flat surface of the piece. The flush position of the sensors enables fast and easy cleaning from oil, dust, water, food spatter, steam, and other pollutants that may reach the sensor and occlude its view, or otherwise adversely affect the function of the sensor. It may be advantageous to place the sensors at a distance from the observation plane between 42 cm-300 cm (16.5″-118.1″).

Sensors, especially those that are positioned above customer-facing assembly lines, may incidentally gather video data of customers or restaurant workers, or other Personally Identifiable Information (PII). For the privacy of customers and restaurant workers, and to comply with local, federal, or state regulations regarding such, it is important to be able to remove sensitive data before it is recorded or transported. Techniques for accomplishing this may include cropping by pixel coordinates, cropping according to color, cropping according to vision AI classification of people, blurring based on vision AI classification of individuals, or cropping or removing areas of the image that have depth readings outside of an expected range that is defined beforehand or in a dynamic manner. The simpler and less compute-intensive methods of these require the sensor to be positioned square with the coordinates of the make line, so that all PII can be eliminated by simply cropping the images in one dimension before they are recorded.

Certain food holding containers may be more advantageous for enabling depth sensing. For instance, pans such as deep hotel pans offer a useful mix of open viewing area to classify foods, and a deep holding container to measure volumetric information. These pans may have a footprint of approximately 30.48 cm (12 inches) long by 16.93 cm (6⅔ inches) wide, or 15.24 cm (6 inches) long by 16.93 cm (6⅔ inches) wide, or 30.48 cm (12 inches) long by 25.4 cm (10 inches) wide, or 10.16 cm (4 inches long) by 16.93 cm (6⅔ inches) wide, or 30.48 cm (12 inches) long by 50.8 cm (20 inches) wide. These pans may measure approximately 15.24 cm (6 inches) deep, or approximately 10.16 cm (4 inches) deep, or approximately 6.35 cm (2½ inches) deep.

### 2D RGB Image Processing

In use cases, where depth sensing cannot be applied, e.g., because the angle at which the pans or containers are viewed is not steep enough, because the depth of a container is low compared to the expected noise of the depth reading, or because the observed item is flat, 2D RGB image processing can be used.

In use cases where the bottom of the container becomes visible immediately as ingredients are used up, rather than taking ingredients from the top, the container's filling level can effectively be described as an area, rather than a volume. In such use-cases, image segmentation can be used to estimate fill levels. If the color of the containers is known, and if it is not contained in the food that is being monitored, simple thresholding methods can be deployed. In more complex situations, clustering, histogram-based methods, edge detection, watershed transformation, or model-based segmentation can be used.

Recognizing that a crew member, or a customer in self-service applications, has taken a scoop out of a container is required for order accuracy, upcharge detection, and cashierless checkout applications. It can also be used to estimate the remaining filling level in containers, where 3d sensing and image segmentation are not applicable. In such applications the amount of scoops in a container is learned from recorded data, or entered by the customer/restaurant crew. Uncertainties, e.g., the standard deviation of the number of scoops in one container, can be calculated and used as a safety margin in applications using the derived filling levels.

Scooping events can either be detected by looking at the person interacting with the food, or by looking at the food itself. When the person is clearly visible, algorithms from the family of pose-estimation algorithms can be used. If the food remains visible while scooping, it can be detected and classified using object detection methods. Rule-based tracking algorithms can follow the food while it is taken out of the container. The scooping events can also be learned from the object's trajectory, or a combination of the trajectory and additional image features, pre-processed from the RGB image.

It is advantageous to use computer vision methods to identify pan positions, including wells that contain empty pans or missing pans. These pans may for example indicate ingredients that are missing from the make line and need to be replenished, ingredients that have been temporarily removed from the line in the process of replenishment, ingredients that have been placed in a non-standard position, or ingredients that have sold out.

E.g., in retrofit cases, where an existing RGB camera (e.g. security camera) is used rather than installing a depth sensor for economic reasons, although the depth sensor would have been beneficial, a depth map can be generated from and RGB image, using deep neural networks.

### RGB+Depth Sensing

There are particularly advantageous elements of applying depth sensing and RGB sensing together, to increase the accuracy of functions or to filter data in real time. An example is using RGB and depth measurements on a region of interest to determine when a pan is occluded from view. RGB streams can be interpreted using computer vision techniques to search for specific known occlusions such as hands or utensils, but this method can fail when an unexpected occlusion enters the region of interest. Depth readings for the corresponding region can be flagged or filtered out (or the whole measurement may be paused until the occlusion is gone from the ROI) if they are outside of an expected range, which can be set statically by a person, or dynamically based on the calibration and detailed setup of the system. An example of this is steam that rises up from a steam table onto a sneeze guard or shield. This is typically identified as an occlusion until the steam dissipates from the sneeze guard.

Events sensed by RGB computer vision can also be used to determine events in a restaurant that augment the depth sensing. For example, crew members that replenish a food pan may do so in different ways that may include discarding old food, combining or “marrying” the old food with the new, or placing the new food in a different position as the old food. RGB streams can be used for classification of pans to determine when more than one pan of the same ingredient is present. RGB-detected events can be used to determine whether food was discarded or was married, and thus can determine the freshness of the food as well as the likely food waste. RGB-detected classifications of food pans can be used to detect foods that are not kept in one static location, but are placed in different positions at different times. Depth measurements can then be used to determine the fill level or available amount of a food throughout the day, with confidence being increased if the fill level data is augmented by the sensing of the pan's position to ensure the right region of interest is selected.

RGB images are processed with a method such as computer vision classification, to determine the pixel coordinates of a given food item. The system uses these pixel coordinates to determine a region of interest in the depth image that corresponds with the location of the food, and then to measure the depth within that region. The system converts the average depth reading inside the region of interest into a fill level that is typically expressed as a percentage.

### Calibration

A major challenge for determining fill levels is to take depth measurements that are calibrated properly. Stereo sensors determine an absolute depth measurement that may fluctuate depending on environmental factors and unavoidable signal noise. Converting this absolute measurement into a % fill level requires setting an appropriate region of interest for the measurement, setting an appropriate depth measurement to represent the bottom of the pan, and an appropriate depth measurement to represent the top of the pan.

An advantage of using stereo imagers is that multiple depth measurements and fill level readings can be obtained from each image. In order to quickly and accurately calibrate multiple measurements, it is advantageous to take depth measurements at multiple points throughout the image to generate a reference plane that is flat in real space. To calculate the 3D position of the plane, the system may add to the measurements coefficients that may include an X-tilt coefficient and a Y-tilt coefficient to account for slight deviations in the angle of the sensor, and a radial coefficient to account for radial warping of the measurements. Based on the deviations of various measurements from the reference plane, the system can determine a relative depth from the reference plane and thus a calibration.

It may be advantageous to correlate the plane to the tabletop, countertop, or pan top rather than the bottoms of the pans because pans in a piece of holding equipment such as a steam table may float when there is less food in them. The calibration must account for this floating with a decreased zero-level, or by calculating fill levels based on the tabletop reading,

One approach to improve the calibration at the top of the pans is to add visual markers such as a QR code or other visual code. These may be added to the countertop for calibration purposes, or to the lids of holding containers such as hotel pans. The QR code gives a non-reflective and textured target to remove noise from the depth readings during calibration.

Similarly, the system may be calibrated according to a plane that corresponds to the bottom of each pan in real space. In this case as well, it is advantageous to process RGB images to find the appropriate regions of interest, but then to gather depth measurements at those locations to determine a reference plane corresponding to the bottom of each pan. Coefficients are again beneficial for converting the raw depth measurements into a plane that is flat in real space.

In each instance of plane generation, the system may use image processing techniques such as masking, computer vision classification, filtration by color, or other image processing techniques to determine which points in the RGB image are part of a flat surface in real space and may be used as a reference plane.

Alternatively, the system may obtain depth measurements for specific defined regions of interest that are set individually based on the positions of empty pans.

It is further advantageous to calibrate multiple observed pans 16 with multiple regions of interest in one image or point matrix or vector, and to associate the measured distance with fill levels of at least two different regions of interest different from one another. Individual configuration files enable the system 100 to set different parameters for fill level at different regions of interest.

To calibrate the sensor 14, a technician places pans 16 or receptacles with different volumetric amounts of product, such as 100%, 50%, 30%, 15%, 5%, and empty, into different pan positions. The technician confirms the fill level of each pan position on a user interface. A configuration file is created for each pan position, including the depth reading at each pan position. When the system 100 is activated for readings, the system 100 reads the depth reading at each pan position, and checks it against the calibration values in the configuration file corresponding to the selected pan position. Once several systems 100 in the same restaurant chain have been calibrated, the system 100 can be calibrated only for empty pans 16, skipping the full and partially full calibration. The system 100 can then learn over time the typical fill level seen in operations.

Volumetric assessment using depth sensing enables the system 100 to measure the available inventory by measuring the fill levels of a previously calibrated pan 16. The process includes methods to lower impact of occlusions, such as taking the longest distance from sensor 14 to food item or using object recognition to identify utensils such as spoons on a corresponding image to carve out a region of interest in a point matrix representing a depth measurement, and/or calculating the average depth value of pixels identified as not being outliers. Volumetric sensing is converted to a % fill level for each pan 16. Correlating the volumetric assessment with food item ingredient data and preparation specific food density, such as for instance a sliced meat to calculate the available food item weight according to reference weights and the current volumetric fill level.

The measured fill levels of the pans or containers or food holding containers 16, which are indicated by the dotted circles in FIG. 1, are comprised in the holding data or food holding data. Said data further includes information about a food holding time of the pan or container 16, a food ingredient associated with the food in the pan or container 16, information about the availability of the food ingredient, and a food ingredient preparation time.

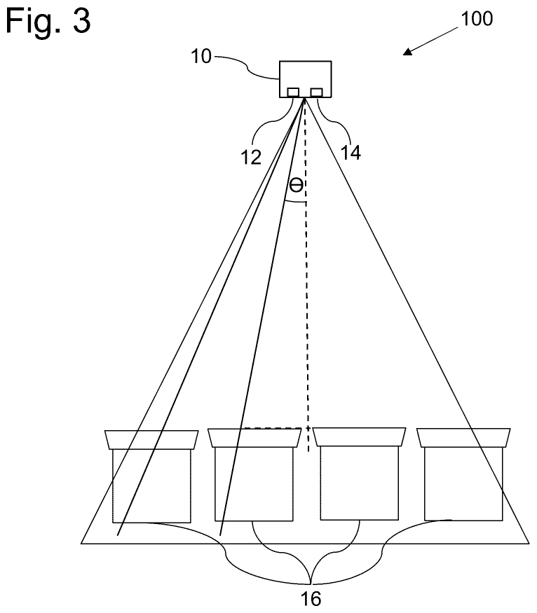

In this context, FIG. 2 shows a simplified schematic view of the holding area or food holding area FHA comprising pans or containers 16. The regions of interest for three pans 16 or containers 16 in this example are indicated by a dashed rectangle. As described above, the occlusions created by the spoons are filtered out of the processed data.

It's beneficial for the system 100 to determine the fill level based on 3D pixel data of the holding area or food holding area FHA. Said 3D pixel data is calculated based on correlating 2D pixel sensor data and depth sensor data, which are determined by the sensor unit 10.

The system 100 then determines regions of interest within the sensor unit's 10 field of view based on the 3D pixel data. In the example shown in FIG. 1, the field of view is indicated by the dashed lines. It is advantageous to associate measured distances or depths of the depth sensor data with fill levels of at least two regions of interest different from one another.

In addition, a heat state fill level is determined based on enhanced 3D pixel data of the holding arca or food holding area FHA by correlating 2D temperature sensor data with 2D pixel sensor data and depth sensor data, which are determined by the sensor unit 10.

The scheduling state or food scheduling state can be based on the current fill level and/or current heat state fill level. Depending on said state specific food cooking commands can be issued by the control unit 20.

Based on the depth reading, pixel coordinates, and pixel size of a pan, a scoop, or a specific serving, the system 100 can calculate the weight or volume of food that was removed from the pan 16 or warm holding container 16. By calculating the size of a serving of food, the system 100 can present information to management about the rate of depletion for each ingredient. The system 100 can identify automatically whether a single or double serving of an ingredient was provided.

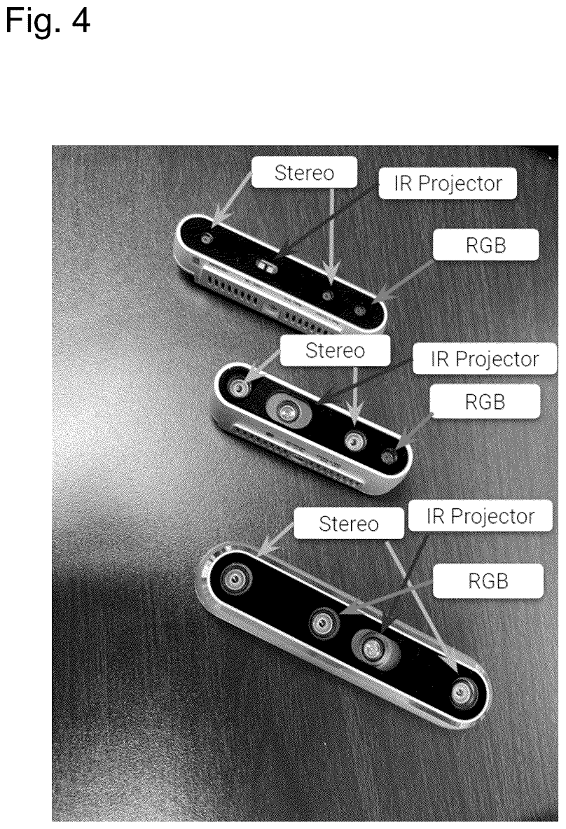

Depth readings may be adjusted based on the pixel coordinates of the reading. The distance from the sensor 14 to the measured position may be multiplied by the cosine of the effective angle Θ to determine the closest distance from the measured point to the plane of the sensor 14. This calculation may be done on a per-pixel basis or for discrete identified regions of interest to reduce the required processing power or CPU load for calculation, FIG. 3 shows an example for adjusting said depth readings. The depth reading for each pan 16 or food holding container 16 can thus be corrected.

It is advantageous to use this method to have a unified observation over multiple locations for a grill or grill warm holding area FHA. The system 100 may track items with object detection including differentiation by caliber (burger patty thickness) and associating timers for each observed grill item. The system 100 may check if timers exceed predefined holding times, such as 5 minutes for a burger patty. The system 100 may initiate an event on a screen or a notification to a crew person once a predefined time is exceeded. The system 100 may calculate a target inventory of food items and initiate an event on a screen or a notification to a crew person once a predefined count or inventory is exceeded or fall below a predefined threshold. The system 100 may dynamically add or reduce the threshold when a customer traffic event occurs and is sensed. A customer traffic event may be a daypart-dependent predefined number to be added to the target inventory in the event a car is detected in drive thru or customer detected walking into the store. For example, a car pulling into a drive thru at 1 pm may represent 1.6 burger patties, 13 ounces of fries, and 3.7 chicken nuggets, which may be added to the demand forecast and threshold.

The system 100 may use action detection to identify start and end time for a certain cooking or preparation action in a kitchen from a video stream. It is advantageous to use measured time or an average over multiple observations of the same action to calculate the current time to complete certain tasks in a kitchen such as breading chicken, distributing dough over a plate, assembling a burger or loading or unloading of a kitchen device such as a fryer or putting items into a bag or tray. It may be advantageous to use the calculated action times to forecast current or future throughput or time to prepare a certain food quantity. Associating the measured timings with expected or measured customer traffic to suggest action items to kitchen crew or adapt staffing plans or order ingredients.

### Production Planning

For fast food restaurants, retail bakeries, fast casual restaurants, other foodservice, or other fresh food retail locations, effective production planning results in food being available and fresh at all hours of the day. To achieve this, the system 100 must use a sales demand prediction to determine the “reach” of each ingredient, defined as the duration that the current inventory will last. Each ingredient has a measurable call time, defined as the duration of time that it takes to prepare and bring fresh ingredients to their destination, once the system has requested that staff prepare them. When the reach of a given ingredient is less than the call time, this is an indication that the production process is behind schedule.

Forecasting from previous sales volume or current customer traffic such as walk-in, inbound digital orders or cars before order point in drive thru, the necessary food item quantity or weight to be cooked in a certain time frame, for instance the next 15 minutes. Forecasting accuracy can be augmented by adding local events, weather, calendar holidays, or other modifications into the calculation of current and future demand. Identifying reorder points using the information of anticipated consumption, to initiate cook commands once fill levels drop below a calculated threshold. In particular of advantage to calculate different reorder points for each time of day and for each ingredient individually. Initiating cook commands to grill, stove, fryer, toaster, ice machine, oven, coffee or beverage maker crew person or automated robotic process once fill levels are below the calculated threshold. Initiating replenish commands to exchange a pan, basket, tray, or other warm holding receptacle, once the receptacle reaches a certain pan fill level.

The scheduling state or food scheduling state is based on a holding data history or a food holding data history. Taking account of said state, and in view of the above, the control unit 20 can forecast from previous sales volume or current customer traffic the necessary food item quantity or weight to be cooked in a certain time frame. Moreover, it can augment the forecasting by adding local events, weather, calendar holidays, or other modifications into the calculation of current and future demand. In addition, reorder points can be identified using the information of anticipated consumption, to initiate cook commands once fill levels drop below a calculated threshold. The control unit 20 can also calculate different reorder points for each time of day and for each ingredient individually.

Identifying replenish events by surpassing a fill level for a pan fill level measurement over a certain time frame. Starting a timer by the replenish event for a predefined ingredient specific holding time. Initiating cook commands to grill, stove, fryer, toaster, ice machine, oven, coffee maker or beverage dispenser crew person or automated robotic process once a predefined time is reached. Initiating replenish commands to exchange pan once a predefined time is reached.

Thus, based on the scheduling state or food scheduling state, the control unit 20 can identify a replenish event when a specific fill level of the pan 16 or food holding container 16 is reached. It can start a timer by the replenish event for a predefined ingredient specific holding time. In addition, it can initiate cook commands to a grill, stove, fryer, toaster, ice machine, oven, coffee maker or beverage dispenser crew person or initiate an automated robotic process once a predefined time is reached. The control unit 20 can also initiate replenish commands to exchange the pan 16 or food holding container 16 once a predefined time is reached.

The system 100 may adjust its requests or cook commands by adding additional time allowances for equipment constraints. For example, a grill surface or fryer vat may be used for multiple ingredients A and B. If ingredient A has a reach of 30 minutes and a call time of 20 minutes, and ingredient B has a reach of 20 minutes and a call time of 10 minutes, the system 100 must order ingredient B now, since the restaurant will need both ingredients within the total call time of the two ingredients. Similarly, each cook command requires a certain measurable labor time to execute the cooking, preparation, and serving of the food. By tracking the available labor and the required labor for each cook command, the system determines when labor constraints would cause delays and can send cook commands earlier depending on the severity in minutes of the anticipated labor shortage.

Operational rules and best practices can be input into the system 100 as assumptions for the calculations. For example, sometimes a new batch of food will replace an old batch and the old batch can be added on top of the new batch; whereas sometimes a new batch will replace an old batch and the old batch will be thrown away. Certain ingredients can be cooked or baked together in the same oven chamber or other cooking device, while certain combinations of ingredients cannot be cooked together for food safety or other reasons. The system 100 plans for this by forecasting sales into the future, planning its next several steps, and combining the requirements for the next several steps.

Certain equipment can cook a linear amount of food, such as a grill surface that holds a specified amount of chicken. However, certain equipment such as fryers can cook larger or smaller batches using the same size oil vat. For example, the system 100 can request larger batches rather than sending multiple smaller batches, since this requires less labor and less space on the fryer or other equipment. Conversely, if the larger batch will cause overproduction and stale food, the system can request more smaller batches. Over time through supervised learning, unsupervised learning, or reinforcement learning, the system 100 makes an ever-improving value-based decision as to which variables are most important to the operation of the kitchen: whether labor or equipment space is the limiting factor at a given time, or whether violating hold times outweigh the equipment or labor concerns.

To include equipment constraints and calculate the effective call times, the system 100 adds together the call times of each ingredient that shares a piece of equipment. The system 100 compares this effective call time against an effective reach, calculated by adding together the reach of the ingredients that need to be cooked. The system 100 decides on a planned order of ingredient cooking, so that the effective call time is less than the effective reach at each intermediate step.

The call times for each ingredient are not perfectly static. Average call times may be estimated, but the true call time depends on the number of outstanding tasks for crew and the amount of staffing available to carry out these tasks. Typically all production planning will include additional time for human or robot execution of the cooking and related processes, as well as a factor of safety in case unforeseen events slow down the production process.

Fresh food has a finite holding time. One result of this fact is that the system 100 must request new production not only when the available inventory is running low, but also periodically to ensure the available food is within its acceptable hold times. The system 100 plans for these batches to be cooked by setting timers from the moment when food is sensed to have been replenished. The system 100 keeps a database of the parameters of each ingredient, including maximum hold times. By subtracting the actual time the food has been on the line from the maximum hold time, the system 100 can determine the time remaining before an ingredient must be replenished. Further subtracting from this the call time for that ingredient, the system 100 can calculate the ideal moment when new food production must be requested from the crew.

The system 100 logs its own requests, the logic for each cook command or request, and when the command was addressed in the kitchen. Measuring the time a cook command was displayed to a crew member and the time the crew member acknowledges or bumps it off the screen or can be seen by action detection that the cooking command is being started to determine a response time. Calculating an average response time over multiple observations. Calculating reorder points over multiple observations.

Using a database to count pans observed entering or exiting certain regions of interests or shelfs within a store.

The system's 100 calculated decisions are executed and lead to a result that either is beneficial or detrimental to the restaurant's operations. Beneficial outcomes include having products available when they are needed, discarding minimal food waste, and serving food with higher freshness than is typically observed. Detrimental outcomes include ingredients stocking out, or having a large amount of food reach its maximum hold time. The system 100 captures each of these signals and improves over time, using an agent such as a reinforcement learning agent. The actions and decisions leading to beneficial outcomes are rewarded, whereas the actions and decisions leading to detrimental outcomes are punished, so they happen less often in similar situations in the future.

In addition to the above, a computer implemented method for processing food according to an embodiment of the present disclosure comprises the following steps:
determining holding data or food holding data of at least one pan (16) or food holding container (16) placed in a holding arca or food holding area;
determining a scheduling state or food scheduling state based on current holding data or food holding data and/or a holding data history or a food holding data history; and
controlling an actuator based on the determined scheduling state or food scheduling state.
Calculating an average fill level based on multiple measurements of the same pan
Using object recognition to identify a pan or container, a combination of food type and pan or container, or a certain combination of pans or containers and food types in a certain layout or a serving area
Comparison of two images to derive depth information or a matrix or array or vector representing the same

The stereo camera sensing can be useful if an IR projector or an RGB LED module is added, black framing or rubber is used for isolation, and if mounted on a ceiling mount USB or Ethernet plugs or a multi axis moving plate are added to the mounting. It is further advantageous to add optical filters such as IR filter, IR passthrough, longpass filters, shortpass filters, bandpass filters, polarizing filters, or visible wavelength passthrough coatings. These can remove noise in depth readings that result from direct light reflections or other sources of data noise.

It is further advantageous if pre-processing of any image data includes the calculation of HDR images or color normalization.

Furthermore, the following steps can be performed:
identifying a replenish event when a specific fill level of the pan 16 or food holding container 16 is reached;
starting a timer by the replenish event for a predefined ingredient specific holding time;
initiating cook commands to a grill, stove, fryer, toaster, ice machine, oven, coffee maker or beverage dispenser crew person or initiate an automated robotic process once a predefined time is reached; and
initiating replenish commands to exchange the pan 16 or container 16 once a predefined time is reached.
initiating a message via display or voice command or buzzer or acoustic signal to the crew indicating a component or food item or item of a pan that has been added to an order although the POS data of that order does not include the component or food item or item of that pan

A computer program comprising instructions that, when executed by the system 100 as described above, causes the system 100 to execute the method steps indicated above.

### Secondary Storage Monitoring

Many ingredients take time to prepare for service, but it is not practical to do preparation during the peak hours of meal times. To solve this problem, many restaurants prepare food ahead of time and use hot or cold storage units where they can keep prepared pans, trays, or other containers of prepared food.

The system 100 needs to manage these storage units in order to instruct crew members when to prepare more food. To track this inventory, the system senses the amount of food that is prepared cold or hot in a storage unit, based on an RFID, QR code, OCR, barcode or other visual or code tag.

System 100 calculates the “reach” in time of the available inventory in secondary storage, and signals kitchen crew or management to prepare, cook, or order more of the item based on the predicted sales volume for that ingredient for the upcoming minutes or hours, or for the rest of the day or week.

Based on the sales demand forecasts, the system 100 can inform crew at the beginning of each day, as well as during off-peak service hours, how much food to prepare and keep in warm or cold storage. These inventory levels are monitored throughout the day, and the need for preparation is recalculated based on dynamic sales forecasts and dynamic sensing of the stored inventory.

The amount of prepared food in secondary storage is often limited by labor. The system 100 can manage the labor required to prepare the forecasted amount of each ingredient, by comparing the average and expected time for each task with the amount of labor available and allocating labor hours to the most pressing tasks.

### Touch (or No-Touch) User Interface

The system 100 further comprises a display unit that is adapted to display the fill levels of the pan 16 or food holding container 16.

User interface displays fill levels of available inventory and/or stored secondary inventory. User interface shows specific cook commands, action items, or requests of the crew.

Each food producer i.e. grill operator, produces food for multiple service channels that each need to be stocked with available inventory. UI specifies for each cook command, not only the type of product and the batch size but also where the cooked product should be sent. For example there may be hot holding at a customer-facing sales channel and at a drive through sales channel. The UI for a production crew member saves time by displaying the destination sales channel(s) for each batch.

The UI may display the cook command before it displays the destination service area. If the destination service area is designated once the food is already cooking, this gives the AI-driven system more time to see how events and inventory levels develop, and to make an appropriate decision.

Batching: UI specifies how much of the product to cook. For each batch, the UI displays a timer on the UI for when to flip or remove items from a cook process such as a grill surface.

The system 100 further applies vision AI.

Vision AI monitors the grill surface or other cooking device, and identifies what items are in the process of cooking. The system 100 automatically changes the state of these items on the UI when cooking, and removes them when cooking is complete. Vision AI also may monitor the crew members and their actions using computer vision, pattern recognition, or action detection algorithms. When the crew member completes the task to be completed, the recognized action is automatically removed from the UI's “to-do” list.

### Automatic Cashier

Using vision AI, the system tracks each burrito, bowl, or other menu item as it's being prepared. In other words, using vision AI, the system tracks each menu item as it's being prepared. As ingredients are added to the item, the system identifies each ingredient and “rings up” the customer for an item containing the ingredients that were served. This automatically detected checkout can be confirmed or modified by a staff member, or can be automatically accepted.

In many restaurants, the ingredients that are used affect the price that the customer should pay for the item. In these cases, the system 100 uses vision detection methods to identify and track both the ingredients, and to which menu item they were added. Each menu item is visually identified and the system tracks a list of ingredients that were added to it, so the software can assign a price to each item based on its ingredients.

### Infrastructure

For robustness of function, it is typically advantageous to have the detection, UI's, and all business or operational calculations occur in devices on site at the edge. Computer vision, machine learning, or other AI models can be updated remotely via the cloud, but deployed directly on devices at the restaurant level. Other software updates can also be engineered remotely and deployed to numerous restaurants during off-hours such as late at night.

The cloud may also be used for reporting. Specified KPIs can be added to a user-customizable dashboard that includes annotated or raw live streams, and relevant information for management regarding staff performance, equipment performance, ingredient availability, food waste, sales forecasts for each ingredient, average freshness or other freshness KPIs for each ingredient, and other relevant data that can be extracted from the AI inference and software.

### Hardware Setup

The following shows the main hardware setup for the system applied to the cases of Production Planning “What to Cook When”, the Order Accuracy, the Upcharge Management, and/or the Cashierless Checkout.

### “What to Cook When”

General Procedure:
Estimate demand
Add safety margin due to
Estimated sensor noise/error (e.g. due to fabrication tolerances of the sensor, reflections of the measured surface or environment, distance of sensor to surface)
Call times
Crew utilization
Measure current filling level
Fire cook command once critical level reached
Demand estimation
Can come from different sources, e.g.
Sales data
Sales predictions and “usage per thousand”
Measured inventory levels
Can be augmented using 3rd party data like weather forecast, traffic, holidays, or events
Can be augmented using other data sources gathered from on-site
Number of cars in drive thru
Number of people in the restaurant
Can be augmented using online order and catering orders
Waste detection/measurement/logging and stockouts as feedback for performance of algorithm
Sensing
Depth
Calibration
Assume observed surface to be flat
Fit 3d plane through surface ob observed table
Estimation of noise
Compare reference surface calculated during calibration to multiple measurements during different times of the day
Gather distribution/likelihood of measurement errors as difference from that surface
Operation outside of sensor specification (min/max distance) adds to noise
Subtract estimated noise as safety margin when estimating current filling levels
2d color
Segmentation
Pseudo-3d
Scoop detection
Empty or missing pan detection
Occlusion detection i.e. steam on sneeze guard, pan lids
Combination of both
Classification/object detection to enable tracking pans as they are
Moved around
Combined
Wasted
Hardware & sensor placement
Optical filter to prevent reflections, or other environmental factors to influence measurement results
Mount perpendicularly over the observed surface to maximize the viewable area and minimize the risk of occlusions
Place such that customers are not visible to reduce risk of recording PII
Hardware or software precautions (cover part of the sensor; apply ROI on incoming images) if customers could be visible
Distance between RGB sensor and stereo sensors

### Order Accuracy

Missing process item triggers actuator
Detect scooping/serving events
Tracking scoops
Determining directionality of movement
Detecting that the direction of movement is towards a region of interest
Tracking entrees from place to place
POS integration: Importing and parsing lists of items that should be in the order
Importing POS data by reading from an HDMI splitter
OCR, pixel-triggered events, or direct data import to read the event
Exporting a signal via HDMI overwrite

### AI Cashierless Checkout

Identify scooping events for each ingredient
Track scoops to the proper entree
Compile running list of which ingredients are added to each entree

### Upcharge Management

Overview

### Sensing

X Identify start and end time for certain cooking or preparation action in a kitchen
Scooping events, serving events, ingredient events
Vision detection of empty pans, missing pans, pan edges, product classification

### Actuators

X Screen
X Robotic arm
X Robotic process
Dispensing a food, beverage, or sauce
Opening a door

Camera position may be directly overhead.

Infrared longpass filters may be about 800 nm.

### Food Tracking and Scheduling Management

While the following sections mainly focuses on an application of this disclosure to retail baking ovens, the disclosure and its workflows generally work with any kitchen appliance and food items that involve a preparation step before the final cooking stage, such as fryers, grills, stoves, grills and ovens and is applicable to restaurants, or quick service restaurants, too.

Typical baking procedures in retail use frozen products that need to rest to defrost before being baked. Even freshly prepared items usually require a wait time to proof before baking. Baking goods are sensitive towards the program/cooking profile used to prepare them as temperature curves, the amount of and time at which steam is introduced to the process, and fan settings. Results are best when the ovens are preheated to the correct temperature. At the same time, keeping ovens preheated all the time is a waste of energy, as baking sessions are usually clustered to certain times of the day to make efficient use of labor. Usually, baking schedules exist, but may not be followed exactly by the crew rendering static, open-loop automation useless.

Baking procedures can be implemented in several ways, adding to the complexity of the setting: trays with food items (such as baking goods) may be kept on a preparation table while they are proofing/defrosting, in a rack, or in an (automatic) loading system while proofing or defrosting. An automatic loading system may be implemented as a rack with an inner frame that can be pushed directly into a corresponding oven without loading individual trays, thereby saving time. Often, these loading systems consist of two parts, related to the upper and lower oven of an oven tower.

As described above, the present disclosure uses optical sensors 12, 14 like cameras to detect and localize accessories used to hold food items during cooking like trays, or food items directly.

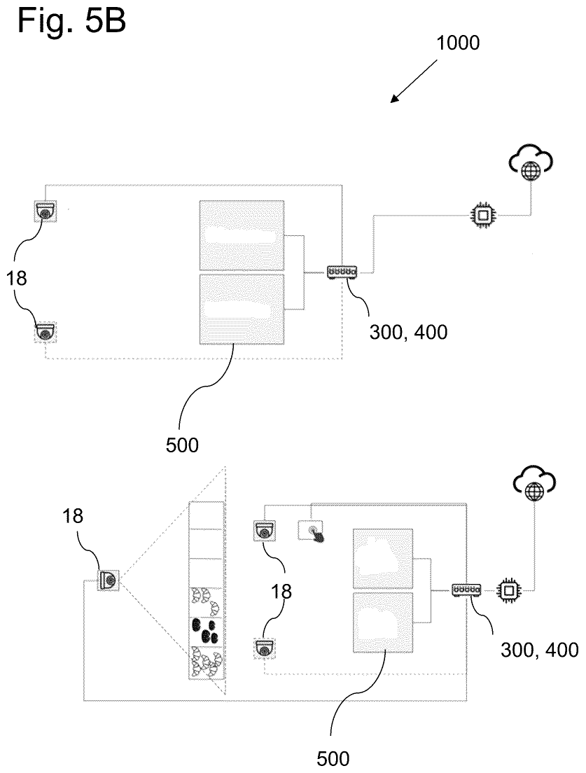

FIGS. 5A and 5B shows an example of a food tracking and scheduling system 1000 according to an embodiment of the present disclosure. The food tracking and scheduling system 1000 comprises a sensor unit 10, a processing unit 300, and a control unit 400.

The sensor unit 10, similar as described above, detects at least one tray or loading system 200 placed in a food holding area FHA and determines holding data of the at least one tray or loading system 200. For example, the sensor unit 10 may comprise at least one of an RGB sensor 12, or other optical sensor 12, and at least one of a depth sensor 14, a thermal sensor 14, a 3D camera 14, a time of flight sensor 14, or a stereo camera 14.

The processing unit 300 determines a cooking schedule based on the holding data and/or a holding data history and selects a cooking device (e.g., a oven 500) based on the determined cooking schedule.

The control unit then controls an actuator based on the determined cooking schedule.

The holding data may comprises information about the kind and number of food items in the tray or loading system 200.

In this context, if an automatic loading system 200 is detected, its load (e.g., which trays belong to the upper or lower part) may be identified and saved alongside the information required to keep track of the loading system 200 while it moves through a kitchen.

To safely detect whether a tray is added to an upper or lower compartment of the loading system, a separate sensor 12, 14 for distance measurement may be added to the setup. Often, this distance measurement may also be approximated using software, e.g. using stereo vision, or creating depth information from a 2d image using machine learning models.

In addition to detecting the compartment of the loading system 200, its exact level may also be detected and signaled to a cooking device such as an oven 500 for further optimization and displaying purposes, e.g., to show which product is placed on which level on a corresponding oven's interface, and/or to create multiple timers for food items using similar cooking parameters but different time durations for cooking.

The cooking schedule may comprise information about the availability of the cooking devices, a current state of the available cooking devices, and a usage pattern of the available cooking devices.

In greater detail, the current state may include a current temperature of one or more ovens 500, which may be identified as available cooking devices. For example, the closer an oven's 500 temperature is to a desired preheating temperature, the less energy is needed for preheating. Furthermore, it may be even more energy efficient to let an oven 500 with a higher temperature cool down to a desired temperature than to heat another oven 500 up to said temperature, even if the difference in temperature is smaller.

The current state may also comprise information regarding a time remaining in a current cooking or baking program executed in an oven 500. That is, the oven 500 may not yet be ready because it is still being used but may be the best choice. For example, if its remaining baking time is shorter or equal as the time needed for proofing/defrosting new food items, and if its expected temperature at the end of the bake procedure is close the required temperature, it may be the most suitable choice.

Further, an oven 500 that may has surpassed a recommended number of baking cycles since the last cleaning session may be less desirable to use than a clean oven 500.

In addition, the current state may also include information regarding a total number of baking cycles completed for a corresponding oven 500.

To spread the expected wear and tear over multiple appliances, also the oven's 500 usage pattern may be factored in, to decide which oven 500 to use next.

According to further configurations, the cooking schedule may also comprise a digital baking schedule configured to substitute or add information to the holding data.

In other words, the cooking schedule may be augmented, or (partially) replaced by the digital baking schedule. This baking schedule may substitute or add to the information otherwise recorded by the sensing unit 10 such as a camera 14. In particular, it may be used anticipate quantities of food items. For example, if the cooking schedule list contains 12 identified trays of bread rolls as the next priority, and the camera 14 detects the first tray, the system 1000 starts heating up a 12 tray oven 500, rather than using a smaller 5 tray oven 500.

Similarly, the system 1000 may interface with or implement features of a demand-based scheduler that dynamically recommends when and how much to prepare next. Information used for the underlying demand prediction includes but is not limited to measurements of walk-in and drive-thru customers, historic and current sales data, weather forecast, traffic information, and measured inventory levels.

Based on the holding data and the cooking schedule, the control unit 400 may further execute the following:
recognize the tray and/or additional trays within the food holding area (FHA);
identify and classify the food items in the tray and/or the additional trays within the food holding area (FHA),
in case that the food items are not compatible to be cooked in combination with each other, generate a warning to be displayed on a user interface (UI);
in case that a loading system (200) is detected, determine the loading systems height and track the loading system (200);
select a cooking program;
select a cooking device;
provide information regarding the loading system (200), the trays, the cooking program and the cooking device to a quality control system (2000);
start preheating the cooking device; and
start preheating the cooking device.

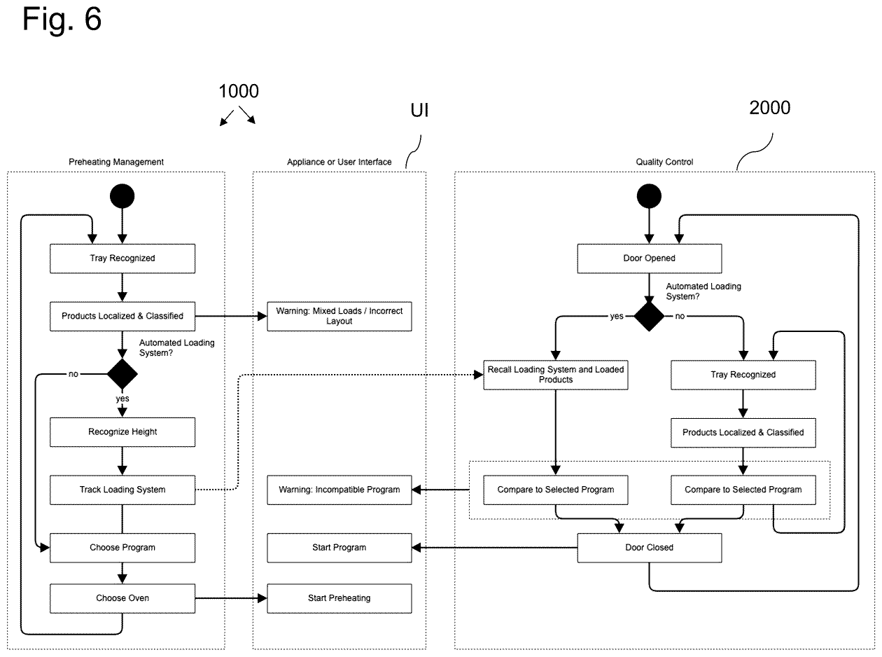

This is illustrated in a simplified manner in FIG. 6. As described above and indicated in FIG. 6, the food tracking and scheduling system 1000 may classify each visible food item and may generate a warning, if a mix of food items that cannot be prepared using the same cooking schedule is detected.

This warning may be presented to a human operator to alert them of potential mistakes and may be signaled, e.g., using a separate user interface (UI), a loudspeaker, or the appliance. If the observed food holding area FHA is too big to be covered by a single sensor, multiple sensor and multiple compute units may work together to cover the scene.

In case of the loading system 200, the user may be warned if a currently added tray requires a cooking profile different from food items previously added to the loading system 200. The system 1000 may be configured/trained to select a cooking program based on its criteria to salvage results as best as possible, such as temperature, or duration, preventing a food item from being rendered inedible/unenjoyable in the cooking process.

The cooking schedule may further based on a holding data history, wherein, based on the cooking schedule, the control unit 400 may further adapted to:
forecast from previous demands the food item quantity to be cooked in a certain time frame.

As described above, the food tracking and scheduling system 1000 may further comprise a display unit (UI) that is adapted to display a warning that the tray comprises mixed food items and an interface for controlling cooking devices.

According to further configurations, it is noted that the controller 400 may be configured to, before signaling a cooking program or a preheating temperature to an actuator such as a cooking device (e.g., an oven 500), select the most suitable device, including but not limited to the criteria/considerations listed above.

In addition to the food tracking and scheduling system 1000, a quality control system 2000 may either be implemented as a separate entity or be implemented in the food tracking and scheduling system 1000.

In greater detail, the quality control system 2000 comprises a sensor unit 10 similar to the hardware described above. The quality control system 2000 executes the following:

in case that a cooking device is opened and receives food items:
determine if a loading system 200 is present in a food holding area FHA;
if a loading system 200 is present, recall the loading system 200 and loaded food items based on information provided by a food tracking and scheduling system 1000;
compare a selected cooking program based on the information provided by the food tracking system 1000 with a program to be executed on the cooking device;
in case that the selected cooking program is not compatible with the cooking program to be executed, generate a warning to be displayed on the user interface UI;
in case that the selected program is compatible with the cooking program, start the cooking program when the cooking device is closed.

The quality control system 2000 may further be configured to execute the following:
if a loading system 200 is not present, recognize a tray and/or additional trays within the food holding area FHA;
identify and classify the food items in the tray and/or the additional trays within the food holding area FHA;
compare a selected cooking program based on the information provided by the food tracking system 1000 with a program to be executed on the cooking device;
in case that the selected cooking program is not compatible with the cooking program to be executed, generate a warning to be displayed on the user interface UI;
in case that the selected program is compatible with the cooking program, start the cooking program when the cooking device is closed.

This is indicated in FIG. 6. Specifically, the quality control system 2000 activates when an oven's 500 door is opened and food items are moved close to it or received by it.

If an automated loading system 200 is detected, its features are compared to previously loaded systems 200 to recall their content (e.g., previous food items). If their content does not match the oven's 500 settings, a warning is displayed in the user interface.

In the absence of an automatic loading system 200, each tray is individually detected and classified as it gets loaded into the oven 500. If food items are introduced that are incompatible with the selected cooking program, a warning is signaled to the user as described above. Distance measurement as described above can be used to approximate the level/height position a tray is inserted to, to allow for a more fine-grained display and further process optimization on the oven's 500 side.

When the door is closed, the oven 500 is either started remotely from the quality control system 2000, or it automatically starts with a pre-selected program.

As described above, the quality control system 2000 may be comprised in the food tracking and scheduling system 1000.

In addition, a computer implemented method for tracking, scheduling and controlling the quality of food comprises:
recognizing a tray and/or additional trays within a food holding area FHA;
identifying and classifying food items in the tray and/or the additional trays within the food holding area FHA;
in case that the food items are not compatible to be cooked in combination with each other, generating a warning and to be displayed on a user interface UI;
in case that a loading system 200 is detected, determining the loading systems height and tracking the loading system 200;
selecting a cooking program;
selecting a cooking device;
providing information regarding the loading system 200, the trays, the cooking program and the cooking device to a quality control system 2000; and
starting preheating the cooking device.

Furthermore, the method may comprise:
in case that a cooking device is opened and receives food items:
determine if a loading system 200 is present in a food holding area FHA;
if a loading system 200 is present, recall the loading system 200 and loaded food items based on information provided by a food tracking and scheduling system 1000;
compare a selected cooking program based on the information provided by the food tracking system 1000 with a program to be executed on the cooking device;
in case that the selected cooking program is not compatible with the cooking program to be executed, generate a warning to be displayed on the user interface UI;
in case that the selected program is compatible with the cooking program, starting the cooking program when the cooking device is closed.

Moreover, if a loading system 200 is not present, the method may comprise:
recognize the tray and/or additional trays within the food holding area FHA)
identify and classify the food items in the tray and/or the additional trays within the food holding area FHA;
compare a selected cooking program based on the information provided by a food tracking system 1000 with a program to be executed on the cooking device;
in case that the selected cooking program is not compatible with the cooking program to be executed, generate a warning to be displayed on the user interface UI;
in case that the selected program is compatible with the cooking program, starting the cooking program when the cooking device is closed.

According to embodiments, a computer program comprises instructions that, when executed by a system 1000, 2000, cause the system 1000, 2000 to execute the method steps described above.

A list of example embodiments follows:
1. Food tracking and scheduling system (1000), comprising:
   a sensor unit (10) for detecting at least one tray or loading system (200) placed in a food holding arca (FHA) and determining holding data of the at least one tray or loading system (200);
   a processing unit (300) for determining a cooking schedule based on the holding data and/or a holding data history and selecting a cooking device based on the determined cooking schedule; and
   a control unit (400) to control an actuator based on the determined cooking schedule.
2. Food tracking and scheduling system (1000) according to item 1, wherein the sensor unit (10) comprises at least one of an RGB sensor (12), or other optical sensor (12), and at least one of a depth sensor (14), a thermal sensor (14), a 3D camera (14), a time of flight (TOF) sensor (14), or a stereo camera (14).
3. Food tracking and scheduling system (1000) according to item 1 or 2, wherein the holding data comprises information about the kind and number of food items in the tray or loading system (200).
4. Food tracking and scheduling system (1000) according to any one of the preceding items, wherein the cooking schedule comprises information about the availability of the cooking devices, a current state of the available cooking devices, and a usage pattern of the available cooking devices.
5. Food tracking and scheduling system (1000) according to item 4, wherein the cooking schedule comprises a digital baking schedule configured to substitute or add information to the holding data.
6. Food tracking and scheduling system (1000) according to any of the preceding items, wherein, based on the holding data and the cooking schedule, the control unit (400) is further adapted to:
   recognize the tray and/or additional trays within the food holding area (FHA);
   identify and classify the food items in the tray and/or the additional trays within the food holding area (FHA),
   in case that the food items are not compatible to be cooked in combination with each other, generate a warning to be displayed on a user interface (UI);
   in case that a loading system (200) is detected, determine the loading systems height and track the loading system (200);
   select a cooking program;
   select a cooking device;
   provide information regarding the loading system (200), the trays, the cooking program and the cooking device to a quality control system (2000);
   start preheating the cooking device; and
   start preheating the cooking device.
7. Food tracking and scheduling system (1000) according to any of the preceding items, wherein the cooking schedule is further based on a holding data history, wherein, based on the cooking schedule, the control unit (400) is further adapted to:
   forecast from previous demands the food item quantity to be cooked in a certain time frame.
8. Food tracking and scheduling system (1000) according to any of the preceding items, wherein the system (1000) further comprises a display unit (UI) that is adapted to display a warning that the tray comprises mixed food items and an interface for controlling cooking devices.
9. A quality control system (2000) comprising a sensor unit (10), wherein the quality control system (2000) is configured to:
   in case that a cooking device is opened and receives food items:
   determine if a loading system (200) is present in a food holding arca (FHA);
   if a loading system (200) is present, recall the loading system (200) and loaded food items based on information provided by a food tracking and scheduling system (1000);
   compare a selected cooking program based on the information provided by the food tracking system (1000) with a program to be executed on the cooking device;
   in case that the selected cooking program is not compatible with the cooking program to be executed, generate a warning to be displayed on a user interface (UI);
   in case that the selected program is compatible with the cooking program, start the cooking program when the cooking device is closed.
10. Quality control system (2000) according to item 9, wherein the quality control system (2000) is further configured to:
   if a loading system (200) is not present, recognize a tray and/or additional trays within the food holding area (FHA);
   identify and classify the food items in the tray and/or the additional trays within the food holding area (FHA);
   compare a selected cooking program based on the information provided by the food tracking system (1000) with a program to be executed on the cooking device;
   in case that the selected cooking program is not compatible with the cooking program to be executed, generate a warning to be displayed on the user interface (UI);
   in case that the selected program is compatible with the cooking program, start the cooking program when the cooking device is closed.
11. Quality control system (2000) according to item 9, wherein the quality control system (2000) is comprised in a food tracking and scheduling system (1000) according to items 1 to 8.
12. Computer implemented method for tracking, scheduling and controlling the quality of food, the method comprising:
   recognizing a tray and/or additional trays within a food holding area (FHA);
   identifying and classifying food items in the tray and/or the additional trays within the food holding area (FHA);
   in case that the food items are not compatible to be cooked in combination with each other, generating a warning and to be displayed on a user interface (UI);
   in case that a loading system (200) is detected, determining the loading systems height and tracking the loading system (200);
   selecting a cooking program;
   selecting a cooking device;
   providing information regarding the loading system (200), the trays, the cooking program and the cooking device to a quality control system (2000); and
   starting preheating the cooking device.
13 The method according to item 12, further comprising:
   in case that a cooking device is opened and receives food items:
   determine if a loading system (200) is present in a food holding area (FHA);
   if a loading system (200) is present, recall the loading system (200) and loaded food items based on information provided by a food tracking and scheduling system (1000);
   compare a selected cooking program based on the information provided by the food tracking system (1000) with a program to be executed on the cooking device;
   in case that the selected cooking program is not compatible with the cooking program to be executed, generate a warning to be displayed on the user interface (UI);
   in case that the selected program is compatible with the cooking program, starting the cooking program when the cooking device is closed.
14. The method according to items 12 or 13, further comprising:
   if a loading system (200) is not present, recognize the tray and/or additional trays within the food holding area (FHA);
   identify and classify the food items in the tray and/or the additional trays within the food holding area (FHA);
   compare a selected cooking program based on the information provided by a food tracking system (1000) with a program to be executed on the cooking device;
   in case that the selected cooking program is not compatible with the cooking program to be executed, generate a warning to be displayed on the user interface (UI);
   in case that the selected program is compatible with the cooking program, starting the cooking program when the cooking device is closed.
15. A computer program comprising instructions that, when executed by a system (1000, 2000), cause the system (1000, 2000) to execute the method of items 12 to 14.

It follows another itemized list of embodiments.
1. Food processing system (100), comprising:
   a sensor unit (10) for determining holding data of at least one pan (16) or holding container (16) placed in a food holding area (FHA);
   a processing unit (18) for determining a scheduling state based on current holding data and/or a holding data history; and
   a control unit (20) to control an actuator (22) based on the determined scheduling state.
2. Food processing system (100) according to item 1, wherein the sensor unit (10) comprises at least one of an RGB sensor (12), or other optical sensor (12), and at least one of a depth sensor (14), a thermal sensor (14), a 3D camera (14), a time of flight sensor (14), or a stereo camera (14).
3. Food processing system (100) according to item 1 or 2, wherein the holding data comprises information about at least one of a fill level of the at least one pan (16) or holding container (16), a holding time of the at least one pan (16) or holding container (16), a food ingredient associated with the food in the pan (16) or holding container (16), information about the availability of the food ingredient, and a food ingredient preparation time.
4. Food processing system (100) according to item 3, wherein the system (100) is adapted to determine the fill level based on 3D pixel data of the food holding area (FHA).
5. Food processing system (100) according to item 4, wherein the system (100) is adapted to calculate the 3D pixel data based on correlating 2D pixel sensor data and depth sensor data, which are determined by the sensor unit (10).
6. Food processing system (100) according to item 5, wherein the system (100) is adapted to:
   determine regions of interest within the sensor unit's (10) field of view based on the 3D pixel data; and
   associate a measured distance or depth of the depth sensor data with fill levels of at least two regions of interest different from one another.
7. Food processing system (100) according to items 2 to 6, wherein the system (100) is adapted to determine a heat state fill level based on enhanced 3D pixel data of the food holding arca (FHA) by correlating 2D temperature sensor data with 2D pixel sensor data and depth sensor data, which are determined by the sensor unit (10).
8. Food processing system (100) according to item 7, wherein the scheduling state is based on the current fill level and/or current heat state fill level.
9. Food processing system (100) according to items 2 to 8, wherein, based on the scheduling state, the control unit (20) is further adapted to:
   identify a replenish event when a specific fill level of the pan (16) or holding container (16) is reached;
   start a timer by the replenish event for a predefined ingredient specific holding time;
   initiate cook commands to a grill, stove, fryer, toaster, ice machine, oven, coffee maker or beverage dispenser crew person or initiate an automated robotic process once a predefined time is reached; and
   initiate replenish commands to exchange the pan (16) or holding container (16) once a predefined time is reached.
10. Food processing system (100) according to items 2 to 9, wherein the scheduling state is further based on a holding data history, wherein, based on the scheduling state, the control unit (20) is further adapted to:
   forecast from previous sales volume or current customer traffic the necessary food item quantity or weight to be cooked in a certain time frame;
   augment the forecasting by adding local events, weather, calendar holidays, or other modifications into the calculation of current and future demand;
   identify reorder points using the information of anticipated consumption, to initiate cook commands once fill levels drop below a calculated threshold; and
   calculate different reorder points for each time of day and for each ingredient individually.
11. Food processing system (100) according to any of the preceding items, wherein the system (100) further comprises a display unit that is adapted to display the fill levels of the pan (16) or holding container (16), available inventory, specific cook commands, action items or requests of a crew person, and/or a destination area for the pan (16) or holding container (16).
12. Food processing system (100) according to any of the preceding items, wherein the system (100) further applies vision AI to monitor a grill surface or other cooking device, and identifies what food ingredients are in the process of cooking.
13. Computer implemented method for processing food, the method comprising:
   determining holding data of at least one pan (16) or holding container (16) placed in a food holding arca (FHA);
   determining a scheduling state based on current holding data and/or a holding data history; and
   controlling an actuator (22) based on the determined scheduling state.
14. Method according to item 13, further comprising:
   identifying a replenish event when a specific fill level of the pan (16) or holding container (16) is reached;
   starting a timer by the replenish event for a predefined ingredient specific holding time;
   initiating cook commands to a grill, stove, fryer, toaster, ice machine, oven, coffee maker or beverage dispenser crew person or initiate an automated robotic process once a predefined time is reached; and
   initiating replenish commands to exchange the pan (16) or holding container (16) once a predefined time is reached.
15. A computer program comprising instructions that, when executed by a system (100), cause the system (100) to execute the method of items 13 to 14.

1-15. (canceled)

16. A system, comprising:
a sensor unit configured to detect a tray or loading system placed in a food holding area and to determine holding data of the tray or loading system;
a processing unit configured to determine a cooking schedule based on the holding data and/or a holding data history and to select a cooking device based on the determined cooking schedule; and
a control unit configured to control an actuator based on the determined cooking schedule.

17. The system of claim 16, wherein the sensor unit comprises at least one of an RGB sensor, or other optical sensor, and at least one of a depth sensor, a thermal sensor, a 3D camera, a time of flight sensor, or a stereo camera.

18. The system of claim 16, wherein the holding data comprises information about a kind and number of food items in the tray or loading system.

19. The system of claim 16, wherein the cooking schedule comprises information about available cooking devices, a current state of the available cooking devices, and a usage pattern of the available cooking devices.

20. The system of claim 19, wherein the cooking schedule comprises a digital baking schedule configured to substitute or add information to the holding data.

21. The system of claim 16, wherein, based on the holding data and the cooking schedule, the control unit is further configured to:
recognize the tray and/or additional trays within the food holding area;
identify and classify the food items in the tray and/or the additional trays within the food holding area,
in case that the food items are not compatible to be cooked in combination with each other, output a warning to a user interface;
in case that a loading system is detected, determine the loading systems height and track the loading system;
select a cooking program;
select a cooking device;
provide information regarding the loading system, the trays, the cooking program and the cooking device to a quality control system; and
start preheating the cooking device.

22. The system of claim 16, wherein the cooking schedule is further based on a holding data history, wherein, based on the cooking schedule, the control unit is further configured to:
forecast from previous demands a food item quantity to be cooked in a time frame.

23. The system of any of claim 16, further comprising:
a display unit that is configured to display a warning that the tray comprises mixed food items; and
an interface for controlling cooking devices.

24. A system, comprising a processor that is configured to receive data from a sensor and to:
in case that a cooking device is opened and receives food items:
determine if a loading system is present in a food holding area;
if a loading system is present, recall the loading system and loaded food items based on information provided by a food tracking and scheduling system; and
compare a selected cooking program based on the information provided by the food tracking system with a program to be executed on the cooking device;
in case that the selected cooking program is not compatible with the cooking program to be executed, generate a warning to be displayed on a user interface; and
in case that the selected program is compatible with the cooking program, start the cooking program when the cooking device is closed.

25. The system of claim 24, wherein the processor is further configured to:
if a loading system is not present, recognize a tray and/or additional trays within the food holding area;
identify and classify the food items in the tray and/or the additional trays within the food holding area;
compare a selected cooking program based on the information provided by the food tracking system with a program to be executed on the cooking device;
in case that the selected cooking program is not compatible with the cooking program to be executed, generate a warning to be displayed on the user interface; and
in case that the selected program is compatible with the cooking program, start the cooking program when the cooking device is closed.

26. The system of claim 24, wherein the sensor comprises at least one of an RGB sensor, or other optical sensor, and at least one of a depth sensor, a thermal sensor, a 3D camera, a time of flight sensor, or a stereo camera.

27. A method, comprising:
recognizing a tray and/or additional trays within a food holding area;
identifying and classifying food items in the tray and/or the additional trays within the food holding area;
in case that the food items are not compatible to be cooked in combination with each other, generating a warning and to be displayed on a user interface;
in case that a loading system is detected, determining the loading systems height and tracking the loading system;
selecting a cooking program;
selecting a cooking device;
providing information regarding the loading system, the trays, the cooking program and the cooking device to a quality control system; and
starting preheating the cooking device.

28. The method of claim 27, further comprising:
in case that a cooking device is opened and receives food items:
determining if a loading system is present in a food holding area;
if a loading system is present, recalling the loading system and loaded food items based on information provided by a food tracking and scheduling system;
comparing a selected cooking program based on the information provided by the food tracking system with a program to be executed on the cooking device;
in case that the selected cooking program is not compatible with the cooking program to be executed, generating a warning to be displayed on the user interface;
in case that the selected program is compatible with the cooking program, starting the cooking program when the cooking device is closed.

29. The method of claim 27, further comprising:
if a loading system is not present, recognizing the tray and/or additional trays within the food holding area;
identifying and classifying the food items in the tray and/or the additional trays within the food holding area;
comparing a selected cooking program based on the information provided by a food tracking system with a program to be executed on the cooking device;
in case that the selected cooking program is not compatible with the cooking program to be executed, generating a warning to be displayed on the user interface;
in case that the selected program is compatible with the cooking program, starting the cooking program when the cooking device is closed.
